(19) United States
(12) Patent Application Publication
(10) Pub. No.: US 2013/0093212 A1
(43) Pub. Date: Apr. 18, 2013

(54) VEHICLE MOUNTING SYSTEM AND METHOD OF MOUNTING AN ACCESSORY TO A VEHICLE

(71) Applicants: Victor Harris, Dubai (AE); Laurence Bridger, Dubai (AE); Oliver Nolden, Koln (DE)

(72) Inventors: Victor Harris, Dubai (AE); Laurence Bridger, Dubai (AE); Oliver Nolden, Koln (DE)

(73) Assignee: NSV LLC, Dubai (AE)

(21) Appl. No.: 13/273,350

(22) Filed: Oct. 14, 2011

(51) Int. Cl. B62D 25/00; B23P 11/00; F16M 13/02

(52) U.S. Cl. 296/191; 248/220.21; 248/222.14; 29/428

(57) ABSTRACT

A mounting system for mounting an accessory to a body panel of a vehicle includes a bezel and a bracket. The accessory is attached to at least one of the bezel and the bracket. The bezel is precisely formed to match a three dimensional shape of an exterior surface of the body panel. The bracket is precisely formed to match a three dimensional shape of an interior surface of the body panel. The bezel is inserted into an opening cut into the body panel from an exterior of the body panel, and the bracket is positioned adjacent the bezel from an interior of the body panel. A fastener connects the bracket to the bezel, or connects the bracket to the accessory which is attached to the bezel, with the body panel positioned therebetween, to secure the mounting system relative to the body panel.

### TECHNICAL FIELD

The invention generally relates to a method of mounting an accessory to a body panel of a vehicle, and a mounting system therefore.

### BACKGROUND

Vehicles are assembled and sold with a standard equipment package. An owner of the vehicle may wish to add an accessory, such as but not limited to additional exterior lighting fixtures, to the vehicle after the vehicle has been manufactured. Such an accessory may be referred to as an aftermarket accessory. It is desirable to securely attach the accessory to a body panel of the vehicle in a manner that makes the aftermarket accessory appear to be part of the standard equipment package of the vehicle.

### SUMMARY

A method of installing an accessory to a body panel of a vehicle is provided. The method includes cutting an opening into the body panel. A mating surface of a bezel is formed to match a shape of an exterior surface of the body panel along an x-axis, a y-axis and a z-axis of the body panel. The bezel is inserted into the opening from an exterior of the body panel. A mating surface of a bracket is formed to match a shape of an interior surface of the body panel along the x-axis, the y-axis and the z-axis of the body panel. The accessory is secured to at least one of the bezel and the bracket. The bracket is fastened to the bezel with the body panel disposed between the bracket and the bezel to secure the accessory relative to the body panel.

A body panel for a vehicle is also provided. The body panel includes a substrate that defines an opening. The substrate includes an exterior surface and an interior surface. Each of the exterior surface and the interior surface form a three dimensional shape along an x-axis, a y-axis and a z-axis. A bezel includes a mating surface that is formed to match the three dimensional shape of the exterior surface of the substrate. The bezel is positioned within the opening, with the mating surface of the bezel disposed adjacent and contacting the exterior surface of the substrate. A bracket includes a mating surface that is formed to match the three dimensional shape of the interior surface of the substrate. The bracket is positioned adjacent the bezel with the mating surface of the bracket disposed adjacent and contacting the interior surface of the substrate. At least one fastener interconnects the bracket and the bezel, with the substrate disposed therebetween and supporting the bracket and the bezel. An accessory is attached to at least one of the bezel and the bracket in a fixed position relative to the substrate.

A mounting system for attaching an accessory to a body panel of a vehicle is also provided. The mounting system includes a bezel formed to match a three dimensional shape of an exterior surface of the body panel in an x-axis, a y-axis and a z-axis of the body panel. A bracket is formed to match a three dimension shape of an interior surface of the body panel in the x-axis, the y-axis and the z-axis of the body panel. At least one fastener interconnects the bezel and the bracket. The bezel is configured for insertion into an opening in the body panel from an exterior of the body panel. The bracket is configured for attachment to the bezel from an interior of the body panel such that the body panel is sandwiched between the bezel and the bracket with the bezel and the bracket conforming to match the three dimensional shape of the body panel to evenly support the body panel about a periphery of the opening.

Accordingly, the formed shapes of the bezel and the bracket perfectly contour to the shape of the body panel and sandwich the body panel therebetween, thereby providing a secure attachment to the body panel while distributing the load around an entire periphery of the opening so as not to damage the body panel. The mounting system provides the ability to easily add an accessory, such as a light fixture, to an existing body panel of the vehicle, such as a bumper or front fascia, without glue and with an original equipment appearance.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view from an exterior position of a body panel of a vehicle showing a bezel of a mounting system in a pre-installation position.

FIG. 2 is a schematic perspective view from the exterior position of the body panel showing the bezel in an installed position.

FIG. 3 is a schematic perspective view from an interior position of the body panel showing the bezel in the installed position and a bracket in a pre-installation position.

FIG. 4 is a schematic perspective view from the interior position of the body panel showing the bracket in an installed position.

FIG. 5 is a schematic perspective view of the bracket.

FIG. 6 is a schematic cross sectional view of the body panel showing the mounting system attached to the body panel.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts throughout the several views, a mounting system is generally shown at 20. The mounting system 20 mounts an accessory 22 to a body panel 24 of a vehicle. The accessory 22 may include but is not limited to a light fixture, such as shown in the Figures. The body panel 24 may include but is not limited to a front fascia or bumper of the vehicle, such as shown in the Figures. While the mounting system 20 is shown and described herein as being configured for mounting a lighting fixture to a front fascia of the vehicle, it should be appreciated that this is merely an exemplary embodiment, and that the accessory 22 may include a device other than the light fixture shown and described herein, and the body panel 24 may include a panel other than the front fascia shown and described herein.

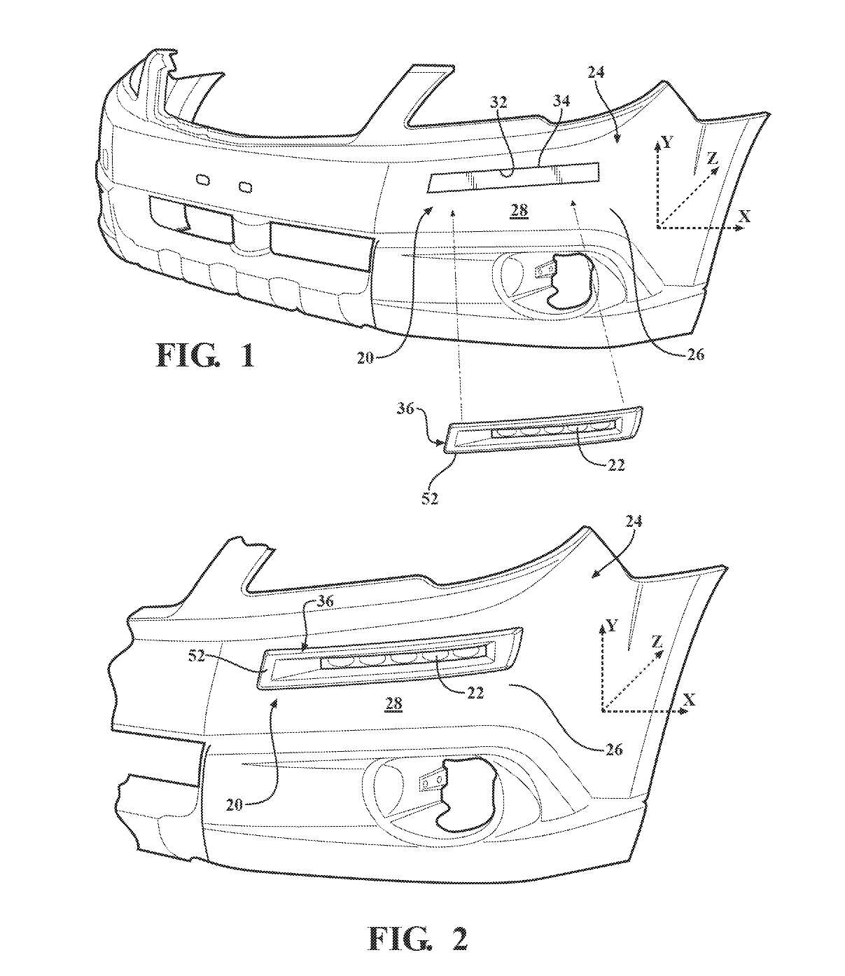

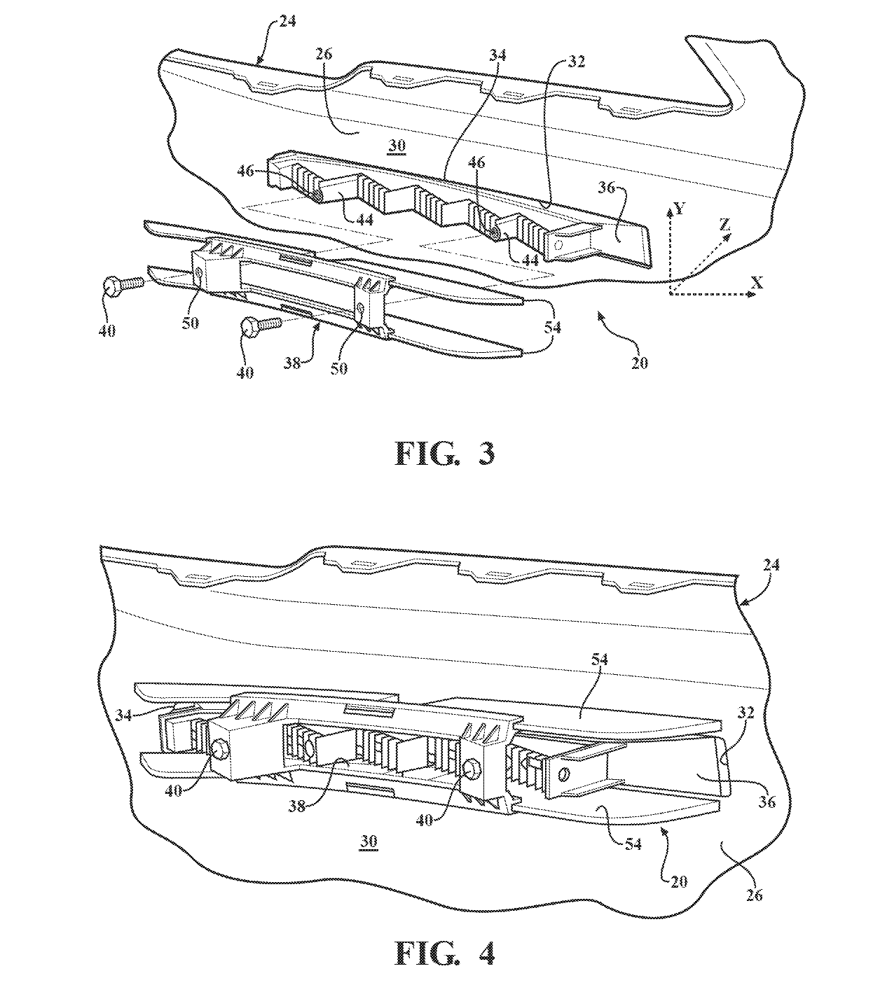

Referring to FIGS. 1 through 4, the body panel 24 includes a substrate 26 that is formed to define the shape of the body panel 24. The substrate 26 may be formed from any suitable material, such as but not limited to a plastic, a metal, fiberglass, or some other similar material. The substrate 26 includes an exterior surface 28, shown in FIGS. 1 and 2, and an interior surface 30, shown in FIGS. 3 and 4. The exterior surface 28 of the substrate 26 defines the exterior of the vehicle. The interior surface 30 of the substrate 26 is disposed opposite the exterior surface 28, and is exposed to an interior space of the vehicle, such as an engine compartment, trunk, etc. Each of the exterior surface 28 and the interior surface 30 of the substrate 26 defines a three dimensional shape contoured along an x-axis, a y-axis and a z-axis. While the three dimensional shape of the interior surface 30 may generally mimic the three dimensional shape of the exterior surface 28, it should be appreciated that slight variations may exist, for example, due to the thickness and/or contour of the substrate 26. Accordingly, the specific three dimensional shape of the exterior surface 28 of the substrate 26 as measured along the x-axis, the y-axis and the z-axis of the substrate 26 is not exactly the same as the three dimensional shape of the interior surface 30 of the substrate 26 as measured along the x-axis, the y-axis and the z-axis of the substrate 26.

In order to secure the mounting system 20 to the body panel 24, an opening 32 is cut into the substrate 26 of the body panel 24. The opening 32 is shown in FIGS. 1 and 3. The opening 32 of the substrate 26 defines a periphery 34. The periphery 34 of the opening 32 is sized and shaped to accommodate the particular size and shape of the accessory 22. The opening 32 is cut into the substrate 26 at the location in which the mounting system 20 is to be installed.

The mounting system 20 includes a bezel 36, a bracket 38, and a plurality of fasteners 40. The plurality of fasteners 40 interconnects the bezel 36 and the bracket 38. Alternatively, the fasteners 40 may connect the bracket 38 to the accessory 22, with the accessory 22 attached to the bezel 36 and thereby connecting the bracket 38 to the bezel 36. When the bezel 36 and the bracket 38 are properly positioned relative to the body panel 24 and secured together with the fasteners 40, the bezel 36 and the bracket 38 cooperated to compress, i.e., sandwich, the body panel 24 therebetween, thereby securing the mounting system 20 to the body panel 24.

The accessory 22 is attached to at least one of the bezel 36 and the bracket 38. Accordingly, the accessory 22 may be attached to either the bezel 36 or the bracket 38, or may be attached to both the bezel 36 and the bracket 38. When the accessory 22 is attached to the mounting system 20, and the mounting system 20 is secured in place relative to the body panel 24, the accessory 22 is then fixed in position relative to the substrate 26.

Referring to FIGS. 1 and 2, the bezel 36 includes a mating surface 42 that is formed to match the three dimensional shape of the exterior surface 28 of the substrate 26. The bezel 36 is positioned within the opening 32, with the mating surface 42 of the bezel 36 disposed adjacent and contacting the exterior surface 28 of the substrate 26. The bezel 36 and/or accessory 22 may include a plurality of bosses 44, with each boss 44 having a threaded bore 46 configured to receive one of the fasteners 40 therein in threaded engagement.

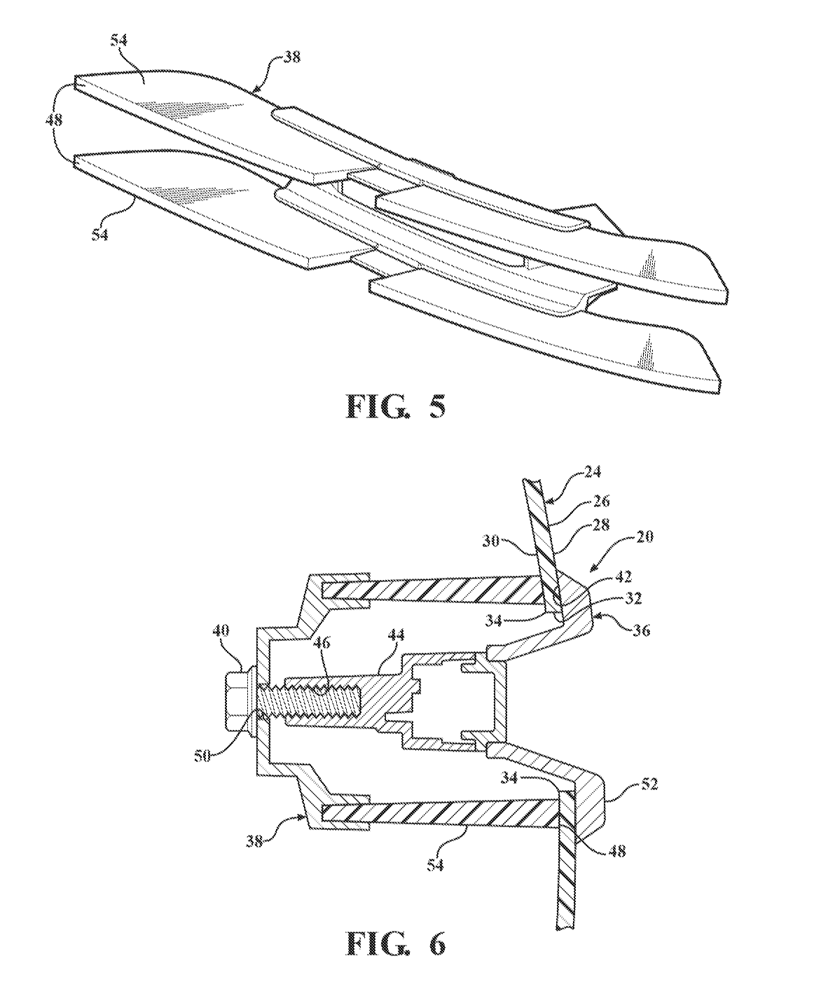

Referring to FIGS. 3 through 5, the bracket 38 includes a mating surface 48 that is formed to match the three dimensional shape of the interior surface 30 of the substrate 26. The bracket 38 is positioned adjacent the bezel 36, with the mating surface 48 of the bracket 38 disposed adjacent and contacting the interior surface 30 of the substrate 26. The bracket 38 may include a plurality of apertures 50, with each aperture 50 aligned with one of the threaded bores 46 and configured for receiving one of the fasteners 40 therethrough. Referring to FIG. 6, it should be appreciated that the fasteners 40 extend through one of the apertures 50 of the bracket 38 and into threaded engagement with one of the threaded bores 46 of the bezel 36 and/or accessory 22, thereby attaching the bracket 38 to the bezel 36 and/or accessory 22. While the exemplary embodiment shown and described herein includes the fasteners 40 extending through the apertures 50 defined by the bracket 38 and into threaded engagement with the threaded bores 46 defined by the bezel 36, it should be appreciated that the relative positions may be reversed such that the bezel 36 defines the apertures 50, the bracket 38 includes the bosses 44 defining the threaded bores 46, and with the fasteners 40 extending through the apertures 50 of the bezel 36 and into threaded engagement with the threaded bores 46 of the bracket 38.

Both of the bezel 36 and the bracket 38 define an outer perimeter region 52, 54. The outer perimeter regions 52, 54 extend radially outward beyond the periphery 34 of the opening 32. Accordingly, the outer perimeter regions 52, 54 of both the bezel 36 and the bracket 38 define a larger area than the periphery 34 of the opening 32. Because the outer perimeter regions 52, 54 of the bezel 36 and the bracket 38 extend outward beyond the periphery 34 of the opening 32, the substrate 26 is completely supported around the entire periphery 34 of the opening 32 between the bezel 36 and the bracket 38. As such, the outer perimeter region 52 of bezel 36 extends outward beyond the opening 32 to surround and completely cover the opening 32 from the exterior surface 28 of the substrate 26. Similarly, the outer perimeter region 54 of the bracket 38 extends outward beyond the opening 32 to surround and completely cover the opening 32 from the interior surface 30 of the substrate 26. As shown in FIG. 6, the substrate 26 is disposed therebetween the bezel 36 and the bracket 38. When the bezel 36 and the bracket 38 are secured in place with the fasteners 40 relative to the substrate 26, the bezel 36 and the bracket 38 support or stiffen the substrate 26 around the periphery 34 of the opening 32, and the substrate 26 supports the bracket 38 and the bezel 36.

The mounting system 20 is attached to the vehicle by first measuring the three dimensional shape of the body panel 24 along each of the x-axis, the y-axis and the z-axis of the body panel 24. More specifically, both the interior surface 30 and the exterior surface 28 of the substrate 26 are measured to determine their precise three dimensional shape. The specific contours of the interior surface 30 and the exterior surface 28 may be measured and referenced to the x-axis, y-axis and z-axis by, for example, electronically scanning the body panel 24 with a scanner, or in some other suitable manner not described herein.

Once the three dimensional shape of the exterior surface 28 and the interior surface 30 of the substrate 26 have been measured, then the mating surface 42 of the bezel 36 is formed to match the three dimensional shape of the exterior surface 28 of the body panel 24 along the x-axis, the y-axis and the z-axis of the body panel 24. Similarly, the mating surface 48 of the bracket 38 is formed to match the three dimensional shape of the interior surface 30 of the body panel 24 along the x-axis, the y-axis and the z-axis of the body panel 24. The bezel 36 and the bracket 38 may be formed in any suitable manner, including but not limited to injection molding the bezel 36 and the bracket 38 from a plastic material, or through standard machining processes. The bezel 36 and the bracket 38 are each formed to match a specific pre-defined body panel 24 having a specific pre-defined shape in each of the x-axis, the y-axis and the z-axis, and are each formed to mate with each other. Accordingly, the each mounting system 20 is formed to match a specific location on a specific body panel of a specific make and model of vehicle.

Once the bezel 36 and the bracket 38 are properly formed to match the contours and shape of a particular body panel 24, then the opening 32 must be cut into the body panel 24 to receive the mounting system 20. In order to cut the opening 32 into the body panel 24, a template may be positioned adjacent the body panel 24 to identify the specific location of the opening 32 on the body panel 24. The specific location for the opening 32 may be marked and the template removed, or the opening 32 may be cut using the template as a guide. As the mounting system 20 is intended to be an aftermarket fitment, the opening 32 may be cut into the body panel 24 after the vehicle is completely assembled. However, it should be appreciated that the mounting system 20 may be attached to the body panel 24 prior to final assembly of the vehicle.

Referring to FIGS. 1 and 2, once the opening 32 is cut into the body panel 24, the bezel 36 is inserted into the opening 32 from an exterior of the body panel 24. The bezel 36 is positioned adjacent the body panel 24 such that the outer perimeter region 52 of the bezel 36 is disposed about and covers the periphery 34 of the opening 32 from the exterior of the body panel 24. Referring to FIGS. 3 and 4, the bracket 38 is then positioned adjacent the bezel 36 from an interior of the body panel 24. The bracket 38 is positioned adjacent the body panel 24 such that the outer perimeter region 54 of the bracket 38 is disposed about and covers the periphery 34 of the opening 32 from the interior of the body panel 24, thereby disposing the body panel 24 between the outer perimeter region 52 of the bezel 36 and the outer perimeter region 54 of the bracket 38

After the bezel 36 and the bracket 38 are positioned relative to each other and the body panel 24, the bracket 38 and the bezel 36 are fastened together with the body panel 24 disposed therebetween. Referring to FIG. 6 and as described above, the bracket 38 may be fastened to the bezel 36 and/or the accessory 22 by inserting a plurality of fasteners 40 through apertures 50 defined by the bracket 38 and into threaded engagement with threaded bores 46 defined by the bezel 36 and/or accessory 22. However, it should be appreciated that the bracket 38 and the bezel 36 may be secured together in some other manner not shown or described herein. Once secured together, the bracket 38 and the bezel 36 cooperate to compress the substrate 26 therebetween, thereby securing the mounting system 20 to the body panel 24. As described above, the accessory 22 may be secured to at least one of the bezel 36 and the bracket 38. The accessory 22 may be secured in any suitable manner, such as with a threaded fastener 40 or the like.

Accordingly, the mounting system 20 described above allows for the accessory 22, such as a light fixture, to be mounted to the body panel 24, such as a bumper, after the vehicle has been assembled without the use of glue or other adhesives, and without ill-fitting mounting brackets. The mounting system 20 mounts the accessory 22 in a manner that makes the accessory 22 appear to be original equipment of the vehicle. Because the bezel 36 and the bracket 38 are formed to precisely match the contours of the interior surface 30 and the exterior surface 28 of the body panel 24 respectively, the mounting system 20 evenly distributes the load across a wide area of the body panel 24 surrounding the opening 32, thereby providing a reliable fitment and preventing deformation of the body panel 24.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1-11. (canceled)

12. A body panel for a vehicle, the body panel comprising:
a substrate defining an opening and having an exterior surface and an interior surface each forming a three dimensional shape along an x-axis, a y-axis and a z-axis;
a bezel having a mating surface formed to match the three dimensional shape of the exterior surface of the substrate, and positioned within the opening with the mating surface of the bezel disposed adjacent and contacting the exterior surface of the substrate;
a bracket having a mating surface formed to match the three dimensional shape of the interior surface of the substrate, and positioned adjacent the bezel with the mating surface of the bracket disposed adjacent and contacting the interior surface of the substrate;
at least one fastener interconnecting the bracket and the bezel, with the substrate disposed therebetween and supporting the bracket and the bezel; and
an accessory attached to at least one of the bezel and the bracket in a fixed position relative to the substrate.

13. A body panel as set forth in claim 12 wherein the substrate is formed to define a front fascia for a vehicle.

14. A body panel as set forth in claim 13 wherein the accessory includes a light fixture.

15. A body panel as set forth in claim 12 wherein the at least one fastener includes a plurality of fasteners in threaded engagement with one of the bezel and the bracket.

16. A body panel as set forth in claim 15 wherein at least one of the bezel or the accessory includes a plurality of bosses each having a threaded bore, and wherein the bracket includes a plurality of apertures, with each aperture aligned with one of the threaded bores, and with one of the plurality of fasteners extending through one of the apertures and into threaded engagement with one of the threaded bores to secure the bracket and the bezel relative to each other.

17. A body panel as set forth in claim 12 wherein the opening of the substrate defines a periphery, and wherein both of the bezel and the bracket define an outer perimeter region extending outward beyond the periphery of the opening such that the substrate is completely supported around the periphery of the opening between the bezel and the bracket.

18. A mounting system for attaching an accessory to a body panel of a vehicle, the mounting system comprising:
a bezel formed to match a three dimensional shape of an exterior surface of the body panel in an x-axis, a y-axis and a z-axis of the body panel;
a bracket formed to match a three dimensional shape of an interior surface of the body panel in the x-axis, the y-axis and the z-axis of the body panel; and
at least one fastener interconnecting the bezel and the bracket;
wherein the bezel is configured for insertion into an opening in the body panel from an exterior of the body panel, and the bracket is configured for attachment to the bezel from an interior of the body panel such that the body panel is sandwiched between the bezel and the bracket with the bezel and the bracket conforming to match the three dimensional shape of the body panel to evenly support the body panel about a periphery of the opening.

19. A mounting system as set forth in claim 18 wherein the at least one fastener includes a plurality of fasteners in threaded engagement with one of the bezel and the bracket.

20. A mounting system as set forth in claim 19 wherein the bezel includes a plurality of bosses each having a threaded bore, and wherein the bracket includes a plurality of apertures, with each aperture aligned with one of the threaded bores, and with one of the plurality of fasteners extending through one of the apertures and into threaded engagement with one of the threaded bores to secure the bracket and the bezel relative to each other.
